(19) United States
(12) Patent Application Publication
(10) Pub. No.: US 2014/0303281 A1
(43) Pub. Date: Oct. 9, 2014

(54) HYBRID LATEX PARTICLES FOR SELF-STRATIFYING COATINGS

(71) Applicant: The Sherwin-Williams Company, (US)

(72) Inventors: Peter J. MACKULIN, North Olmsted, OH (US); Randolph B. KRAFCIK, Aurora, OH (US)

(73) Assignee: THE SHERWIN-WILLIAMS COMPANY, Cleveland, OH (US)

(21) Appl. No.: 13/804,193

(22) Filed: Mar. 14, 2013

(51) Int. Cl. C09D 7/12

(52) U.S. Cl. CPC C09D 7/125
USPC 523/205; 524/544

(57) ABSTRACT

The present invention relates to coating compositions formed by combining two latex resins: a base latex resin and a stratifying latex resin. The stratifying latex resin comprises hybrid metal oxide latex particles wherein the hybrid particles are the polymerization reaction product of at least one or more copolymerizable monoethylenically unsaturated monomers, wherein the monoethylenically unsaturated monomers comprise at least one low surface energy driver monomer selected from the group consisting of (i) a fluorine containing monomer; and (ii) a silane-containing monomer; and wherein the polymerization reaction is in the presence of a metal oxide nanoparticle; and wherein the metal oxide nanoparticle is embedded within the hybrid particles.

### FIELD OF THE INVENTION

The present invention is directed to coating compositions comprising metal oxide hybrid latex particles which are self-stratifying or self-layering, and a method for forming such coating compositions. According to this invention, metal oxide nanoparticles are embedded within a hybrid latex particle in a self-stratifying latex composition. Such self-stratifying latex composition can be used as an additive to base latex resins for enhancing the washability, ultraviolet absorbance and other performance characteristics of a coating composition.

### SUMMARY OF THE INVENTION

Coatings according to the present invention comprise a base latex resin and a stratifying latex resin, wherein the stratifying latex is formulated with hybrid metal oxide latex particles. In accordance with this invention, the stratifying latex comprises hybrid metal oxide nanoparticles, wherein the metal oxide nanoparticles are embedded within the hybrid latex particle. The hybrid particles are the polymerization reaction product of at least one or more copolymerizable monoethylenically unsaturated monomers, wherein the monoethylenically unsaturated monomers comprise at least one low surface energy driver monomer selected from the group consisting of a fluorine-containing monomer and a silane-containing monomer and wherein the polymerization reaction is in the presence of metal oxide nanoparticles.

### BRIEF DESCRIPTION OF THE DRAWINGS

FIG. 1 is a transmission electron microscopy (TEM) image (1000×) of a hybrid TiO2 nanoparticle surrounded by the stratifying latex resin of this invention. As can be seen from the TEM image, the TiO2 nanoparticle hybrid of the present invention is comprised of particles 5-20 nanometers in size, embedded within hybrid latex particles.

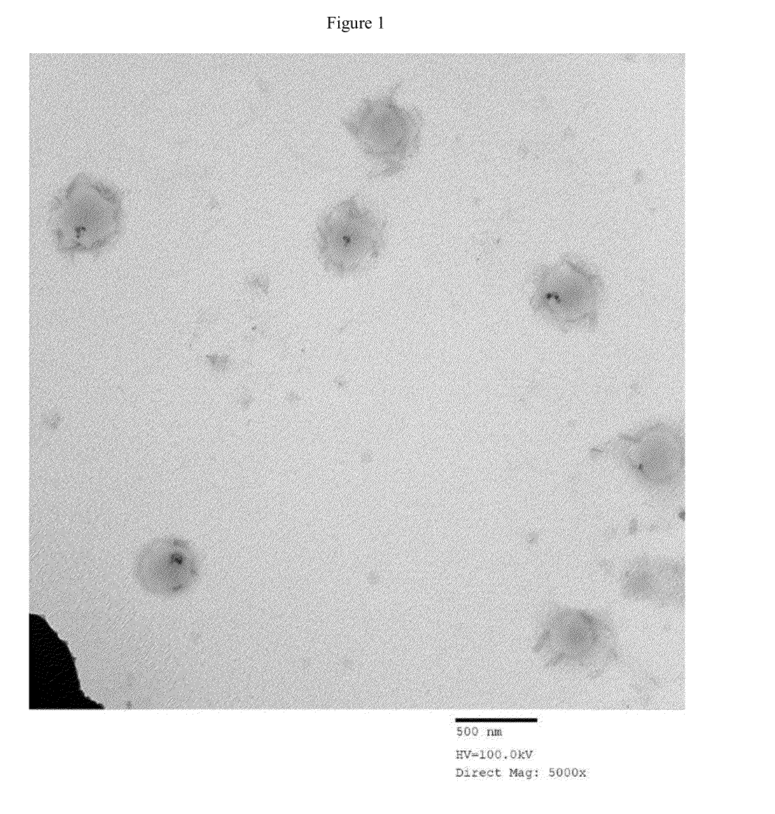

FIG. 2 is a UV-Vis absorbance spectra of the stratified latex coating composition of this invention, compared to a latex coating composition control and a coating composition with post-added TiO2 nanoparticles, all at 1 mil film thickness.

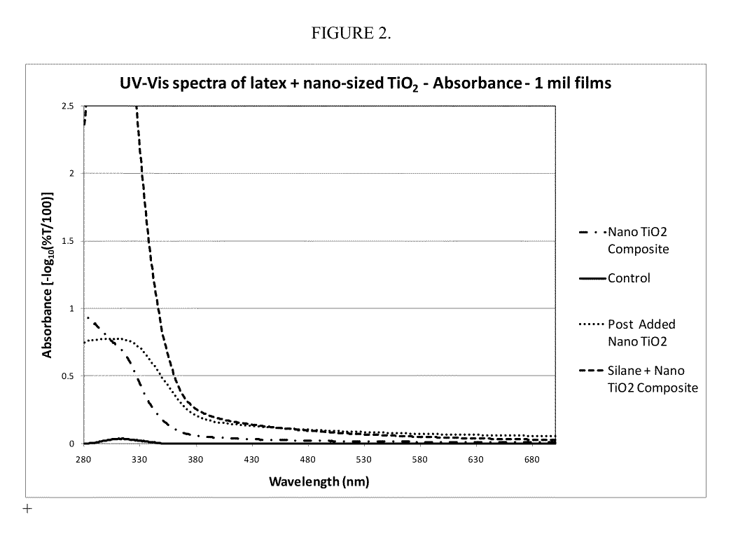

### DETAILED DESCRIPTION OF THE INVENTION

The present invention comprises a coating composition including a base latex resin and a stratifying latex resin comprising hybrid latex particles of metal oxide nanoparticles embedded within a stratifying latex resin.

The hybrid particle of this invention are clusters of metal oxide nanoparticles that are embedded within a stratifying latex resin particle, that result from the polymerization of the starting nanoparticles in an aqueous dispersion with at least one stratifying latex monomer, such as a low energy driver monomer selected from the group consisting of a fluorine-containing monomer and a silane-containing monomer. As used herein, such hybrid metal oxide nanoparticles are also referred to as “hybrid metal oxide latex particles.” Nanoparticles suitable for preparing the hybrid particles of this invention can be selected from metal oxides such as aluminum oxide, antimony tin oxide, bismuth oxide, cerium oxide, iron oxide titanium dioxide, zinc oxide, to name a few, and mixtures thereof. Such metal oxide nanoparticles are well-known and commercially available in a range of particle sizes and morphologies as aqueous dispersions.

Both the base latex and the stratifying latex include polymers polymerized from one or more suitable monomers. Typically, the resins are polymerized from one or more copolymerizable monoethylenically unsaturated monomers, such as, for example, vinyl monomers and/or acrylic monomers.

Vinyl monomers suitable for use in accordance with the polymers of the present invention include any compounds having vinyl functionality, i.e., ethylenic unsaturation, exclusive of compounds having acrylic functionality, e.g., acrylic acid, methacrylic acid, esters of such acids, acrylonitrile and acrylamides. In one embodiment of the invention, the vinyl monomers are selected from vinyl esters, vinyl aromatic hydrocarbons, vinyl aliphatic hydrocarbons, vinyl alkyl ethers and mixtures thereof.

Suitable vinyl monomers also include vinyl esters, such as, for example, vinyl propionate, vinyl laurate, vinyl pivalate, vinyl nonanoate, vinyl decanoate, vinyl neodecanoate, vinyl butyrates, vinyl benzoates, vinyl isopropyl acetates and similar vinyl esters; vinyl aromatic hydrocarbons, such as, for example, styrene, methyl styrenes and similar lower alkyl styrenes, chlorostyrene, vinyl toluene, vinyl naphthalene and divinyl benzene; vinyl aliphatic hydrocarbon monomers, such as, for example, vinyl chloride and vinylidene chloride as well as alpha olefins such as, for example, ethylene, propylene, isobutylene, as well as conjugated dienes such as 1,3 butadiene, methyl-2-butadiene, 1,3-piperylene, 2,3-dimethyl butadiene, isoprene, cyclohexene, cyclopentadiene, and dicyclopentadiene; and vinyl alkyl ethers, such as, for example, methyl vinyl ether, isopropyl vinyl ether, n-butyl vinyl ether, and isobutyl vinyl ether.

The acrylic monomers suitable for use in accordance with the polymers of the present invention comprise any compounds having acrylic functionality. Acrylic monomers may be selected from the group consisting of alkyl acrylates, alkyl methacrylates, acrylate acids and methacrylate acids as well as aromatic derivatives of acrylic and methacrylic acid, acrylamides and acrylonitrile. In one useful embodiment, the alkyl acrylate and methacrylic monomers (also referred to herein as “alkyl esters of acrylic or methacrylic acid”) may have an alkyl ester portion containing from 1 to about 12, for example about 1 to 5, carbon atoms per molecule.

Suitable acrylic monomers include, for example, methyl acrylate and methacrylate, ethyl acrylate and methacrylate, butyl acrylate and methacrylate, propyl acrylate and methacrylate, 2-ethyl hexyl acrylate and methacrylate, cyclohexyl acrylate and methacrylate, decyl acrylate and methacrylate, isodecyl acrylate and methacrylate, benzyl acrylate and methacrylate, isobornyl acrylate and methacrylate, neopentyl acrylate and methacrylate, 1-adamatyl methacrylate and various reaction products such as butyl, phenyl, and cresyl glycidyl ethers reacted with acrylic and methacrylic acids, hydroxyl alkyl acrylates and methacrylates such as hydroxyethyl and hydroxypropyl acrylates and methacrylates, amino acrylates, methacrylates as well as acrylic acids such as acrylic and methacrylic acid, ethacrylic acid, alpha-chloroacrylic acid, alpha-cyano acrylic acid, crotonic acid, beta-acryloxy propionic acid, and beta-styryl acrylic acid.

In addition to the specific monomers described above, those skilled in the art will recognize that other monomers such as, for example, allylic monomers, or monomers which impart wet adhesion, e.g., methacrylamidoethyl ethylene urea, can be used in place of, or in addition to, the specifically described monomers in the preparation of the polymers used in the present invention. Further details concerning such other monomers suitable for copolymerization in accordance with the present invention are known to those skilled in the art. The amount of such other monomers is dependent on the particular monomers and their intended function, which amount can be determined by those skilled in the art.

Polymer resins used in the present invention may also comprise acid functional latexes. Specific acid functional monomers suitable for use in accordance with polymers of the present invention include, for example, acrylic acid, methacrylic acid, ethacrylic acid, itaconic acid, maleic acid, dimeric acrylic acid or the anhydrides thereof. Besides carboxylic acids and anhydrides, monomers possessing other acid groups such as sulfonic or phosphoric acid groups are also useful. Representative monomers include ethylmethacrylate-2-sulfonic acid, 2-acrylamido-2-methylpropane sulfonic acid, 2-methyl-2-propenoic acid ethyl-2-phosphate ester (HEMA-phosphate), (1-phenylvinyl)-phosphonic acid, or (2-phenylvinyl)-phosphonic acid. Mixtures of acids are also practical.

Polymers of the present invention may also have “latent crosslinking” capabilities, which as used herein means a monomer which possesses the ability to further react some time after initial formation of the polymer. Activation can occur through the application of energy, e.g., through heat or radiation. Also, drying can activate the crosslinking polymer through changes in pH, oxygen content or other changes that causes a reaction to occur. The particular method of achieving crosslinking in the binder polymer is not critical to the present invention. A variety of chemistries are known in the art to produce crosslinking in latexes.

Representative examples of latent crosslinking monomers are those which contain hydrolyzable organosilicon bonds. Examples are the copolymerizable monomers methacryloyloxy-propyl-tri-methoxy-silane, methacryloyloxy-propyl-tri-ethoxy-silane, methacryloyloxy-propyl-tri-propoxy-silane, viny-ltri-methoxy-silane, vinyl-tri-ethoxy-silane, vinyl-iso-propoxy-silane, gamma-amino-triethoxy-silane, cyclo-aliphatic epoxy-tri-methoxy-silane, and gamma-methacryloxy-propyl-tri-methoxy-silane. The silane functionality of polymers incorporating these monomers are capable of reacting with moisture for the crosslinking reaction. Additional latent crosslinking monomers include carbonyl-containing monomers such as acrolein, methacrolein, diacetone acrylamide, diacetone methacrylamide, 2 butanone methacrylate, formyl styrol, diacetone acrylate, diacetone methacrylate, acetonitrile acrylate, acetoacetoxyethyl methacrylate, acetoacetoxyethyl acrylate and vinylaceto acetate. These monomers normally do not affect crosslinking until during final film formation. In some embodiments, the aqueous polymer emulsion may simultaneously contain an appropriate added amount of a reactive material such as a polyamine compound as crosslinker for the latent crosslinking functionality. Particularly suitable compounds of this type are the dihydrazides and trihydrazides of aliphatic and aromatic dicarboxylic acids of 2 to 20 carbon atoms. Polyamine compounds useful as crosslinkers for the carboxyl functional groups include those having an average of at least two carbonyl-reactive groups of the formula —NH₂ and carbonyl reactive groups derived from such groups. Examples of useful amine functional groups include R—NH₂, R—O—NH₂, R—O—N═C<, R—NH—C(═O)—O—NH₂, wherein R is alkylene, alicyclic or aryl and may be substituted. Representative useful polyamines include ethylene diamine, isophorone diamine, diethylenetriamine and dibutylenetriamine. In one embodiment of this invention it is useful to utilize polyhydrazides as the polyamine compounds. Representative useful polyhydrazides include oxalic dihydrazide, adipic dihydrazide, succinic dihydrazide, malonic dihydrazide, glutaric dihydrazide, phthalic or terephthalic dihydrazide and itaconic dihydrazide. Additionally, water-soluble hydrazines such as ethylene-1,2-dihydrazine, propylene-1,3-dihydrazine and butylene-1,4-dihydrazine can also be used as one of the crosslinking agents.

Epoxy-, hydroxyl- and/or N-alkylol-containing monomers, for example, glycidyl acrylate, N-methylolacrylamide and -methacrylamide and monoesters of dihydric alcohols with α,β-monoethylenically unsaturated carboxylic acids of 3 to 6 carbon atoms, such as hydroxyethyl, hydroxy-n-propyl or hydroxy-n-butyl acrylate and methacrylate are also suitable for postcrosslinking. Primary or secondary amino containing acrylates or methacrylates such as t-butyl amino ethyl methacrylate are also suitable.

Preparation of latex compositions is well known in the paint and coatings art. Any of the well known free-radical emulsion polymerization techniques used to formulate latex polymers can be used in the present invention. Such procedures include, for example, single feed, core-shell, and inverted core-shell procedures which produce homogeneous or structured particles. In one embodiment of the present invention, one or both of the resins may comprise a single polymer formed from a mix of monomers as described herein. In another useful embodiment, one or both of the resins may comprise a combination of two polymers. Combinations of two polymers may be included in coating compositions as a blend of preformed (separately prepared) polymers, or as a sequentially-formed composition of the polymers, whereby one polymer has been prepared in the presence of another, preformed, polymer. As used herein “two-stage polymer” refers to an overall polymer where one polymer is formed in the presence of another, preformed, polymer. Without being limited to any particular theory, this polymerization process possibly, but not necessarily, results in the two polymers having a core/shell particle arrangement. In some two-stage polymers, the two polymer segments will have different Tg's. In such cases, one stage may be referred to as the hard segment (higher Tg), while the other stage is referred to as the soft segment (lower Tg). The term Tg means polymer glass transition temperature.

A crosslinker for reaction with the latent crosslinking functionality may be added to coating compositions of the present invention. The crosslinker need only be present in an amount necessary to achieve the desired degree of cure. For many applications, the crosslinker will typically be present at a level to provide at least 0.1 equivalent for each equivalent of latent crosslinking functionality.

In one of the embodiments of this invention, the crosslinker would be present at a level to provide between about 0.2 to about 2.0 equivalents for each equivalent of latent crosslinking functionality. In some useful embodiments the crosslinker will be present at a level to provide 0.4 to about 1.2 equivalents for each equivalent of latent crosslinking functionality. In another useful embodiment the crosslinker would be present at a level to provide about 0.4 to about 1.0 equivalent for each equivalent of latent crosslinking functionality.

While the polymers used in the base latex and the stratifying latex are formed from similar monomers as described above, the stratifying latex further comprises one or more “drivers” which serve to promote migration of the stratifying latex to the surface of the coating or to an interfacial layer within the coating composition during curing or drying. One such driver comprises including a low surface energy group in the polymer. The low surface energy group aids in creating surface energy differences between the base polymer and the stratifying resin. The low surface energy group may also be used to create surface energy differences between the two stages in the two stage polymer. One type of low surface energy group comprises semi-flourinated groups. In one useful embodiment of the invention, a fluorinated monomer having the formula:

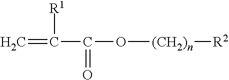

in which R¹ represents CH₃ or H; R² represents a perflourinated C₁-C₁₀ alkyl radical; and n≦4 is used in forming the stratifying resin for use in the present invention. Examples of such monomers include, but are not limited to 2,2,2-trifluoroethyl acrylate, 2,2,2-triflouroethyl methacrylate, 2,2,3,3-tetrafluoropropyl acrylate, 1H, 1H, 5H-octafluoropentyl acrylate, and 1H, 1H, 5H-octafluoropentyl methacrylate. In one useful embodiment, the low surface energy group allows a layer to form in the coating at an interface between two layers of coatings. In another useful embodiment, the low surface energy group may be an air-philic group, which aids the stratifying resin in going to the surface of the coating that is exposed to the air.

According to one embodiment, the low surface energy group may contain a silane group such as those previously identified for the base latex composition. Examples are the copolymerizable monomers methacryloyloxy-propyl-tri-methoxy-silane, methacryloyloxy-propyl-tri-ethoxy-silane, methacryloyloxy-propyl-tri-propoxy-silane, vinyl-tri-methoxy-silane, vinyl-tri-ethoxy-silane, vinyl-iso-propoxy-silane, gamma-amino-triethoxy-silane, cyclo-aliphatic epoxy-tri-methoxy-silane, and gamma-methacryl-oxy-propyl-trimethoxy silane. Commercially available (meth)acrylated alkoxysilanes useful for this invention include CoatOSil® silanes, available from Momentive Performance Materials, Geniosil silanes from Wacker, and Z-type silanes from Dow Corning.

In one useful embodiment, the stratifying resin comprises about 0.2% to about 20%, for example, about 0.5% to about 16%, further for example, up to about 8%, by weight based on the total monomer weight, of a monomer containing a fluorine-containing monomer, or a silane-containing monomer, or both.

Another driver useful in the stratifying resin of the present invention is the incorporation of a long chain acrylate monomer having an alkyl length of at least twelve, for example lauryl methacrylate. In one useful embodiment, the stratifying resin comprises about 1% to about 5%, for example, about 2% to about 5%, by weight based on the total monomer weight, of a long chain acrylate monomer having an alkyl length of at least 12.

According to this invention, the stratifying resin comprises a metal oxide nanoparticle, wherein the nanoparticle acts as a seed in the emulsion polymerization with the stratifying monomers to form a hybrid metal oxide latex particle. In such an embodiment, the metal oxide nanoparticle would be part of the core of a two-stage polymer. The hybrid metal oxide latex particle is the polymerization reaction product of at least one or more copolymerizable monoethylenically unsaturated monomers, wherein the monoethylenically unsaturated monomers comprise at least one low surface energy driver monomer selected from the group consisting of a fluorine containing monomer and a silane-containing monomer; and wherein the polymerization reaction is in the presence of the metal oxide nanoparticle, and the nanoparticle becomes embedded within the hybrid particle. In one embodiment, the metal oxide nanoparticles diameters less than 100 nm or less and are dispersed in water. Nanoparticles suitable for preparing the hybrid particles of this invention can be selected from metal oxides such as aluminum oxide, antimony tin oxide, bismuth oxide, cerium oxide, iron oxide, zinc oxide, to name a few. For example, commercially available aqueous dispersions of metal oxide nanoparticles useful for this invention can include, but not limited to, Hombitec RM300wp nonphotocatalytic TiO2 nano water dispersion from Sachtleben Chemie GmbH, TRAFe CSB101W yellow transparent iron oxide water dispersion, commercially available from Chemsfield Co. Ltd., Nanobyk LP-X21530 photocatalytic grade TiO2 nano water dispersion, commercially available from Byk Chemie, and Nanobyk 3810 CeO2 nano water dispersion, commercially available from Byk Chemie.

In one useful embodiment of the present invention, the stratifying latex comprises a two-stage polymer where the lower Tg segment (the “softer” polymer) is the core in the core/shell particle arrangement while the higher Tg material (the “harder” polymer) is the shell. In another useful embodiment, one or more of the fluorine-containing and/or silane-containing drivers as described herein is contained in the softer core segment of such a polymer. In another embodiment, the metal oxide hybrid particles are embedded within the lower Tg “softer” polymer. In yet another embodiment, the hard shell segment is polymerized from a mix of monomers substantially or totally free of any stratification drivers, including fluorinated monomers or lauryl methacrylate. It should be understood that this is included by way of example only and is not intended to exclude the use of an opposite core/shell arrangement in the present invention or the inclusion of one or more drivers on either segment of the two-stage polymer. In one embodiment of the present invention, the soft segment has a Tg of about −35° C. to about 10° C. while the hard segment has a Tg from about 35° C. to about 100° C. Without being limited to any particular theory, it is believed that the soft-segment containing the metal oxide hybrid particles of the stratifying resin is able to percolate to the surface of the coating.

In one embodiment of the present invention, the average particle size of the hybrid latex particles is between about 75 nm to 500 nm, or about 2 to about 100 times the average particle size of the nanoparticles, as measured by using a transmission electron microscope (TEM). In one such embodiment, the stratifying latex resin particles have smaller average particle size than the base latex. Without being bound by any particular theory, it is believed that the smaller particles may also facilitate stratification by being squeezed to the surface of the coating as the larger base latex particles cure.

The stratification drivers disclosed herein could each be used individually or could be used together in any combination to promote the formation of layers within the coating film.

To form a coating composition the base latex and the stratifying latex are combined. The base latex may be selected from any latexes capable of coalescence. Coalescence is the formation of a film by resin or polymer particles upon the evaporation of water or solvent from an emulsion or latex system, which permits contact and fusion of adjacent particles The coating composition may comprise about 2.5% to about 95% by weight, based on the total polymer solids, stratifying latex. For example, for some applications the coating composition may contain about 10% to about 25% by weight, based on the total polymer solids, stratifying latex. In other exemplary embodiments, the coating composition may contain about 25% to about 50%, for example about 30% to about 40% by weight, based on the total polymer solids, stratifying latex. In some embodiments, the components of the coating composition of the present invention separate during curing or drying to form layers of macroscopically measurable proportions. As such, the base latex and stratifying latex may be formulated to provide desired characteristics to each coating layer. For example, the latexes may be formulated to separate to provide the benefits of a base coat/clear coat system in a single coating composition. In order to achieve stratification, at least a portion of the base latex must have a higher surface tension than the stratifying latex.

In addition to the base latex and the stratifying latex resins, coating compositions in accordance with the present invention may also comprise various pigments, e.g. color pigments, corrosion inhibiting pigments, UV absorbers, hindered amine light stabilizers, plasticizers, rheology modifiers, specialty co-polymers, dispersants, surfactants, defoamers and other additives.

The following examples are presented to illustrate specific embodiments and practices of the present invention to allow a more complete understanding of the invention. Unless otherwise stated “parts” means parts-by-weight and “percent” is percent-by-weight. Unless otherwise noted, the polymers of Examples 1-4 may be prepared by the following procedure: the components of the Charge mixture are added to the reaction vessel under a nitrogen blanket. The polymerization reactions may be carried out at 80° C. to 85° C.±2° C. 0 to 10% of Pre-emulsion #1 may be added to the Charge mixture. Next the Seed Initiator may be added to the reaction vessel. Then, the rest of Pre-emulsion #1 and Initiator #1 may be added to the reaction vessel simultaneously over 1-3 hours. The reaction may then be held at about 80° C. to about 85° C. for about 30-60 minutes. For single stage latexes, the next step is cooling for the addition of the Chase Oxidizer and Chase Reducer. For two stage latexes, Pre-emulsion #2 and Initiator #2 may then be added to the reaction vessel simultaneously over 1-3 hours and reaction held at about 80° C. to about 85° C. for about 45 to about 120 minutes. For both single stage and two-stage latexes, the vessel may then be cooled to about 65° C. and the Chase Oxidizer and Chase Reducer may be added over about 30 minutes and then held for about 30-60 minutes at about 60-65° C. The vessel may be cooled to below about 40° C. and the Adjustment is added. The Charge Surfactant and PE Surfactant #1, in each case, is an anionic phosphate ester ethoxylated surfactant, which may be selected from TRYFAC™ surfactant from Cognis, RHODAFAC™, RS Series or RE Series, or SOPROPHOR™ surfactants from Rhodia, DEXTROL™ or STRODEX™ surfactants from Aqualon, T-MULZ™ surfactant from Harcros, or anionic sulfate esters ethoxylated surfactants selected from DISPONIL™ surfactant from Cognis, RHODAPEX™ or ABEX™ surfactants from Rhodia, or TDA or 23E sulfates from Sasol. PE Surfactant #1 can optionally be the same as PE Surfactant #2, a nonionic ethyoxylated alochol surfactant which may be selected from, for example, commercially available IGEPAL, SOPROPHOR and RHODASURF from Rhodia, NOVEL TDA and NOVEL 23 from Sasol, POLYSTEP TD, POLYSTEP F AND POLYSTEP TSP from Stepan and DISPONIL AND TRYCOL from Cognis. Buffer, in each case, may be selected from 26% aqueous ammonia solution, sodium carbonate, or sodium bicarbonate. Defoamer, in each case, may be selected from Byk's defoamer line, Cognis' FOAMMASTER™ line, or Emerald Specialities FOAMBLAST™ line. EXAMPLE 1

A representative stratifying latex comprising TiO2 nanoparticle hybrid particles may be prepared as follows:

### Example 1

A representative stratifying latex comprising TiO2 nanoparticle hybrid particles may be prepared as follows:

| Component | Percent by weight |
|---|---|
| Charge | |
| DI Water | 25.5 |
| Surfactant | 0.1 |
| TiO2 Nanoparticle | 4.25 |
| Surfactant #2 | 0.22 |
| Pre-emulsion #1 | |
| DI Water | 8.88 |
| PE Surfactant #1 | 0.65 |
| PE Surfactant #2 | 0.26 |
| Buffer | 0.34 |
| Methacrylic Acid | 0.28 |
| Methacryl-functional silane | 0.86 |
| Lauryl Methacrylate | 1.01 |
| Methyl Methacrylate | 6.67 |
| 2,2,2 Trifluoroethyl Methacrylate | 1.61 |
| 2-Ethylhexyl acrylate | 13.03 |
| Dodecyl mercaptan | 0.01 |
| Seed Initiator | |
| DI Water | 0.72 |
| Ammonium Persulfate | 0.09 |
| Oxidizer | |
| DI Water | 3.24 |
| Ammonium Persulfate | 0.07 |
| Pre-emulsion #2 | |
| DI Water | 7.84 |
| PE Surfactant #1 | 0.32 |
| PE Surfactant #2 | 0.26 |
| Buffer | 0.14 |
| Methacrylic Acid | 0.10 |
| Methacryl-functional silane | 0.86 |
| Methyl Methacrylate | 13.9 |
| 2-Ethyl Hexyl Acrylate | 1.0 |
| DI Water Line Rinse | 1.01 |
| Initiator #2 | |
| DI Water | 2.44 |
| Ammonium Persulfate | 0.04 |
| Chase Oxidizer | |
| DI water | 0.76 |
| t-Butyl Hydroperoxide | 0.07 |
| Chase Reducer | |
| DI water | 0.97 |
| Reducing agent | 0.09 |
| Adjustment | |
| DI Water | 2.01 |
| Buffer | 0.20 |
| Biocide | 0.23 |
| Defoamer | 0.01 |

A latex prepared according to the above could have a theoretical Tg of −17 C. (core)/87° C. (shell), a particle size of 130 nm, a viscosity of 88.0 cps and a weight percent solids of 42%..

### Example 2

A representative stratifying latex comprising TiO2 nanoparticle hybrid particles may be prepared as follows:

| Component | Percent by weight |
|---|---|
| Charge | |
| DI Water | 25.92 |
| Surfactant #1 | 0.10 |
| TiO2 Nanoparticle | 4.32 |
| Surfactant #2 | 0.22 |
| Pre-emulsion #1 | |
| DI Water | 9.04 |
| PE Surfactant #1 | 0.67 |
| PE Surfactant #2 | 0.26 |
| Buffer | 0.35 |
| Methacrylic Acid | 0.28 |
| Lauryl Methacrylate | 1.02 |
| Methyl Methacrylate | 6.79 |
| 2,2,2 Trifluoroethyl Methacrylate | 1.64 |
| 2-Ethylhexyl acrylate | 13.26 |
| Dodecyl mercaptan | 0.01 |
| Seed Initiator | |
| DI Water | 0.73 |
| Ammonium Persulfate | 0.01 |
| Oxidizer | |
| DI Water | 3.30 |
| Ammonium Persulfate | 0.07 |
| Pre-emulsion #2 | |
| DI Water | 7.98 |
| PE Surfactant #1 | 0.32 |
| PE Surfactant #2 | 0.26 |
| Buffer | 0.15 |
| Methacrylic Acid | 0.10 |
| Methyl Methacrylate | 14.14 |
| 2-Ethyl Hexyl Acrylate | 1.02 |
| DI Water Line Rinse | 1.02 |
| Initiator #2 | |
| DI Water | 2.48 |
| Ammonium Persulfate | 0.04 |
| Chase Oxidizer | |
| DI water | 0.77 |
| t-Butyl Hydroperoxide | 0.07 |
| Chase Reducer | |
| DI water | 0.99 |
| Reducing agent | 0.09 |
| Adjustment | |
| DI Water | 2.04 |
| Buffer | 0.20 |
| Biocide | 0.23 |
| Defoamer | 0.01 |

### Example 3

A representative stratifying latex comprising CeO2 nanoparticle hybrid particles may be prepared as follows:

| Component | Percent by weight |
|---|---|
| Charge | |
| DI Water | 25.5 |
| Surfactant | 0.1 |
| CeO2 Nanoparticle | 4.25 |
| Surfactant #2 | 0.22 |
| Pre-emulsion #1 | |
| DI Water | 8.88 |
| PE Surfactant #1 | 0.65 |
| Surfactant #2 | 0.26 |
| Buffer | 0.34 |
| Methacrylic Acid | 0.28 |
| Methacryl-functional silane | 0.86 |
| Lauryl Methacrylate | 1.01 |
| Methyl Methacrylate | 6.67 |
| 2,2,2 Trifluoroethyl Methacrylate | 1.61 |
| 2-Ethylhexyl acrylate | 13.03 |
| Dodecyl mercaptan | 0.01 |
| Seed Initiator | |
| DI Water | 0.72 |
| Ammonium Persulfate | 0.09 |
| Oxidizer | |
| DI Water | 3.24 |
| Ammonium Persulfate | 0.07 |
| Pre-emulsion #2 | |
| DI Water | 7.84 |
| PE Surfactant #1 | 0.32 |
| PE Surfactant #2 | 0.26 |
| Buffer | 0.14 |
| Methacrylic Acid | 0.10 |
| Methacryl-functional silane | 0.86 |
| Methyl Methacrylate | 13.9 |
| 2-Ethyl Hexyl Acrylate | 1.0 |
| DI Water Line Rinse | 1.01 |
| Initiator #2 | |
| DI Water | 2.44 |
| Ammonium Persulfate | 0.04 |
| Chase Oxidizer | |
| DI water | 0.76 |
| t-Butyl Hydroperoxide | 0.07 |
| Chase Reducer | |
| DI water | 0.97 |
| Reducing agent | 0.09 |
| Adjustment | |
| DI Water | 1.78 |
| Buffer | 0.20 |
| Biocide | 0.23 |
| Defoamer | 0.01 |

A latex prepared according to the above could have a theoretical Tg of −15 C. (core)/85° C. (shell), a particle size of 240 nm, a viscosity of 88 cps and a weight percent solids of 42%.

### Example 4

A representative single stage base latex may be prepared as follows:

| Component | Parts by weight |
|---|---|
| Charge | |
| DI Water | 359 |
| Surfactant #1 | 0.8 |
| Ammonium Persulfate | 0.8 |
| Buffer | 0.2 |
| Pre-emulsion #1 | |
| DI Water | 148.7 |
| PE Surfactant #1 | 7 |
| PE Surfactant #2 | 7.2 |
| Buffer | 2 |
| Methacrylic Acid | 7.2 |
| 2-Ethyl Hexyl Acrylate | 164.7 |
| Methyl Methacrylate | 28.4 |
| Styrene | 187.8 |
| Wet adhesion monomer | 16.5 |
| Initiator #1 | |
| DI Water | 42.3 |
| Ammonium Persulfate | 0.8 |
| Chase Oxidizer | |
| DI water | 8.5 |
| t-Butyl Hydroperoxide | 0.6 |
| Chase Reducer | |
| DI water | 8.5 |
| Isoascorbic Acid | 0.4 |
| Buffer | 0.2 |
| Adjustment | |
| DI Water | 1.3 |
| Buffer | 5.3 |
| Biocide | 2 |

The resulting latex has a theoretical Tg of 16° C.

### Example 5

An exemplary paint composition may be made by mixing the following

| Material | Parts by weight |
|---|---|
| Grind | |
| Water | 13.52 |
| Aqueous ammonia | 0.32 |
| Rheology modifier¹ | 1.26 |
| Dispersant² | 0.65 |
| Surfactant³ | 0.29 |
| Dispersant⁴ | 0.31 |
| Titanium dioxide⁵ | 14.79 |
| Let Down | |
| Stratifying latex of Example 1 or 2 or 3 | 16.27 |
| Base latex of Example 3 | 48.81 |
| Propylene glycol | 1.80 |
| Glycol ether DPnB | 0.74 |
| Propylene glycol phenyl ether | 0.43 |
| Plasticizer⁶ | 0.42 |
| Rheology modifier⁷ | 0.39 |

¹Acrysol RM2020 rheology modifier from Dow.
²TAMOL 165-A dispersant from Dow.
³TRITON CF-10 surfactant from Dow.
⁴BYK 024 dispersant from Byk.
⁵R-706 TiO₂ from DuPont.
⁶BenzoFlex B50 plasticizer from Genovique Specialities.
⁷Acrysol RM825 rheology modifier from Dow.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

What is claimed is:

1. An aqueous coating composition comprising:
(a) a base latex resin; and
(b) a stratifying latex resin comprising hybrid metal oxide latex particles wherein the hybrid particles are the polymerization reaction product of at least one or more copolymerizable monoethylenically unsaturated monomers, wherein the monoethylenically unsaturated monomers comprise at least one low surface energy driver monomer selected from the group consisting of (i) a fluorine containing monomer; and (ii) a silane-containing monomer; and wherein the polymerization reaction is in the presence of a metal oxide nanoparticle; and wherein the metal oxide nanoparticle is embedded within the hybrid particles.

2. The aqueous coating composition of claim 1, wherein the coating composition comprises about 2.5% to about 95% by weight stratifying resin, based on the total polymer solids weight.

3. The aqueous coating composition of claim 1, wherein the coating composition comprises about 25% to about 50% by weight stratifying resin, based on the total polymer solids weight.

4. The aqueous coating composition of claim 1, wherein the coating composition comprises about 25 to about 35% by weight stratifying resin, based on the total polymer solids weight.

5. The aqueous coating composition of claim 1, wherein the at least one fluorine containing monomer has the formula: 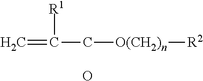
in which R¹ represents CH₃ or H; R² represents a perflourinated C₁-C₁₀ alkyl radical; and n≦4.

6. The aqueous coating composition of claim 1, further comprising at least one monomer having latent crosslinking functionality.

7. The aqueous coating composition of claim 6, wherein the latent crosslinking monomer is a silane monomer.

8. The aqueous coating composition of claim 6, wherein the latent crosslinking monomer is a carbonyl-containing monomer.

9. The aqueous coating composition of claim 1, wherein the metal oxide nanoparticle is selected from the group consisting of aluminum oxide, antimony tin oxide, bismuth oxide, cerium oxide, iron oxide, titanium dioxide, zinc oxide and mixtures thereof.

10. The aqueous coating composition of claim 1, wherein the stratifying latex resin further comprises at least one long chain acrylate monomer having an alkyl length of at least 12.

11. The aqueous coating composition of claim 1, wherein the stratifying latex resin comprises the polymerization reaction product of:
(a) about 2% to about 24% by weight based on the total monomer weight of a fluorine containing monomer;
(b) about 2% to about 6% by weight based on the total monomer weight of a monomer having silane functionality; and
(c) about 1% to about 5% by weight based on the total monomer weight of a long chain acrylate monomer having an alkyl length of at least 12.

12. The aqueous coating composition of claim 1, wherein the stratifying latex resin is a two-stage polymer formed by sequentially polymerizing a first group of monomers to form a first stage polymer and a second group of monomers to form a second stage polymer.

13. The aqueous coating composition of claim 12, wherein the two-stage polymer comprises a soft segment having a Tg from about −35° C. to about 10° C. and a hard segment having a Tg from about 35° C. to about 100° C.

14. The aqueous coating composition of claim 13, wherein the first stage polymer is the soft segment.

15. The aqueous coating composition of claim 13, wherein the metal oxide hybrid particles are embedded within the soft segment.

16. The aqueous coating composition of claim 10, wherein the soft segment comprises the polymerization reaction product of:
(a) about 2% to about 12% by weight based on the total monomer weight of a fluorine containing monomer;
(b) about 2 to about 6% by weight based on the total monomer weight of a monomer having silane functionality; and
(c) about 1 to about 5% by weight based on the total monomer weight of a long chain acrylate monomer having an alkyl length of at least 12.

17. The aqueous coating composition of claim 13, wherein the hard segment comprises the polymerization reaction product of one or more copolymerizable monoethylenically unsaturated monomers excluding fluorine containing monomers and long chain acrylate monomers having an alkyl length of at least 12.

18. The aqueous coating composition of claim 6, wherein the at least one monomer having latent crosslinking functionality is selected from acrolein, methacrolein, diacetone acrylamide, diacetone methacrylamide, 2 butanone methacrylate, formyl styrol, diacetone acrylate, diacetone methacrylate, acetonitrile acrylate, acetoacetoxyethyl methacrylate, acetoacetoxyethyl acrylate, and vinylaceto acetate.

19. The aqueous coating composition of claim 18 further comprising:
an effective crosslinking amount of a crosslinking agent for the stratifying resin.

20. The aqueous coating composition of claim 19, wherein the crosslinking agent is selected from di and poly amines, di and poly hydrazides, and di and poly hydrazines, and mixtures thereof.

21. The aqueous coating composition of claim 6, wherein the at least one monomer having latent crosslinking functionality is selected from the group consisting of methacryloyloxypropyltrimethoxysilane, methacryloyloxypropyltriethoxysilane methacryloyloxypropyltripropoxysilane, vinyltrimethoxysilane, vinyltriethoxysilane, vinylisopropoxysilane, gamma-amino triethoxy silane, cycloaliphatic epoxide trimethoxy silane, and gamma-methacryloxy propyl trimethoxy silane.

22. The aqueous coating composition of claim 1, wherein the stratifying latex resin has an average particle size of about 75 nm to about 500 nm.

23. An aqueous coating composition comprising:
(1) a base latex resin;
(2) a stratifying latex resin comprising hybrid metal oxide latex particles wherein the hybrid particles are the polymerization reaction product of at least one or more copolymerizable monoethylenically unsaturated monomers, wherein the monoethylenically unsaturated monomers comprise at least one low surface energy driver monomer selected from the group consisting of (i) a fluorine containing monomer; and (ii) a silane-containing monomer; and wherein the polymerization reaction is in the presence of a metal oxide nanoparticle; and wherein the metal oxide nanoparticle is embedded within the hybrid particles.

24. The aqueous coating composition of claim 23, wherein the soft core segment of the stratifying latex resin further comprises fluorine groups.

25. The aqueous coating composition of claim 23, wherein the soft core segment of the stratifying latex resin further comprises silane groups.

26. The aqueous coating composition of claim 20, wherein the hybrid metal oxide latex particles have an average particle size in the range of 75 nm to 500 nm.

27. A stratifying latex resin comprising hybrid metal oxide latex particles wherein the hybrid particles are the polymerization reaction product of at least one or more copolymerizable monoethylenically unsaturated monomers, wherein the monoethylenically unsaturated monomers comprise at least one low surface energy driver monomer selected from the group consisting of (i) a fluorine containing monomer; and (ii) a silane-containing monomer; and wherein the polymerization reaction is in the presence of a metal oxide nanoparticle; and wherein the metal oxide nanoparticle is embedded within the hybrid particles.
